(19) United States
(12) Patent Application Publication
(10) Pub. No.: US 2025/0003513 A1
(43) Pub. Date: Jan. 2, 2025

(54) MODULARLY STRUCTURED VALVE ARRANGEMENT FOR A HOUSING

(71) Applicant: Carl Freudenberg KG, Weinheim (DE)

(72) Inventors: Thomas HADAMTZIK, Weisenheim am Sand (DE); Michael Paul Horst SOENDGEN, Bensheim (DE); Adrian BAUR, Mannheim (DE); Christian KLEINKE, Darmstadt (DE)

(21) Appl. No.: 18/358,974

(22) Filed: Jul. 26, 2023

(30) Foreign Application Priority Data
Jun. 30, 2023 (DE) 10 2023 117 379.0

(51) Int. Cl. F16K 27/00; F16K 24/04

(52) U.S. Cl. CPC F16K 27/003; F16K 24/04

(57) ABSTRACT

A modular valve arrangement for a housing includes at least two ventilation valves and at least two carrier plates, wherein each ventilation valve is accommodated by a carrier plate of the at least two carrier plates, and wherein the ventilation valves are connected to each other in a modular manner by their corresponding carrier plate.

### CROSS REFERENCE TO RELATED APPLICATIONS

This application claims benefit to German Patent Application No. DE 10 2023 117 379.0, filed on Jun. 30, 2023, which is hereby incorporated by reference herein.

### FIELD

The invention relates to a valve arrangement for a housing.

BACKGROUND From DE 10 2017 003 360 B3, a valve arrangement for a housing is known, comprising a ventilation valve mounted on a housing. The ventilation valve is formed by a pressure compensation device, the pressure compensation device in this case having an inner side, an outer side and a grid-shaped cage, with a gas passage opening, the gas passage opening connecting the inner side and the outer side as a function of differential pressure in a flow-conducting manner. The gas passage opening is covered by a gas-permeable diaphragm, to which a pressure relief valve configured as burst protection is assigned in a functional parallel circuit.

### SUMMARY

In an embodiment, the present disclosure provides a modular valve arrangement for a housing comprising at least two ventilation valves and at least two carrier plates, wherein each ventilation valve is accommodated by a carrier plate of the at least two carrier plates, and wherein the ventilation valves are connected to each other in a modular manner by their corresponding carrier plate.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a perspective view from above of a modular valve arrangement;

FIG. 2 illustrates the valve arrangement from FIG. 1 in a perspective view from below;

FIG. 3 illustrates a perspective view of the end piece of the valve arrangement from FIG. 1;

FIG. 4 illustrates a top view of the end piece from FIG. 3;

FIG. 5 illustrates a view from below of the end piece from FIG. 4;

FIG. 6 illustrates a side view of the end piece from FIG. 3;

FIG. 7 illustrates a perspective top view of one of the modules from FIG. 1;

FIG. 8 illustrates the module from FIG. 7 in a top view;

FIG. 9 illustrates a view from below of the module shown in FIG. 8; and

FIG. 10 illustrates a front view of the module shown in FIG. 8.

### DETAILED DESCRIPTION

In an embodiment, the present invention provides a valve arrangement for a housing, which can be better adapted in a simple manner to the respective conditions of the application. In this adaptation, development effort and additional investments resulting therefrom should be kept to a minimum. In addition, such a valve arrangement should be simple and cost-efficient to manufacture and easy to mount.

In an embodiment of the invention, a modular valve arrangement for a housing is provided, comprising at least two ventilation valves and at least two carrier plates, each ventilation valve being accommodated by a carrier plate, and the ventilation valves being connected to each other in a modular manner by means of their corresponding carrier plate.

The modular structure of the valve arrangement is advantageous in that it can be easily adapted ideally to the respective conditions of the application.

If, for example, a higher ventilation performance is required in an application, additional ventilation valves can be added to the two existing ventilation valves on their corresponding carrier plates by simply connecting their carrier plates to the existing carrier plates. Such simple expandability means that no additional development effort is required for the adaptation of the valve arrangement to the respective conditions of the application. Investments for an adaptation are thus limited to a minimum. The modular expansion is technically straightforward and can be carried out quickly and reliably.

The ventilation valves can preferably each form a pre-assemblable unit with their corresponding carrier plates. Hereby advantageous is, that the units can be preassembled by the manufacturer. The pre-assembled units then only have to be adapted to the application, assembled modularly by the customer, and connected to the housing. This minimizes the assembly effort required by the customer.

The ventilation valves and the corresponding carrier plates can be materially bonded to each other, preferably welded to each other. In this way, the ventilation valves are connected to each other in a particularly durable and tight manner.

The ventilation valves and the corresponding carrier plates are preferably connected to each other in a non-destructively detachable manner. The advantage hereby is that the valve arrangement can be recycled in a correctly sorted manner after use. In addition, it is possible to reuse the carrier plates, which are subject to practically no wear, as often as required and, for example, to fit them with new ventilation valves of the same or different specification.

The ventilation valves and the corresponding carrier plates can be connected to each other with a force-fitting and/or form-fitting connection. For example, the ventilation valves can be connected to the corresponding carrier plates by a bayonet lock. Such a connection is easy to assemble and also holds securely during a long period of use.

The carrier plates can each have a first and a second longitudinal boundary, the first boundary of one of the carrier plates being force-fittingly and/or form-fittingly connected to the second boundary of the adjacent other carrier plate. The modular structure can be achieved simply by joining together the carrier plates accommodating the ventilation valves. A force-fitting and/or form-fitting connection can be achieved, for example, by screwing the adjacent carrier plates together. Also a latching connection, in which elastically flexible latching hooks latch into undercuts, is conceivable.

For example, the first boundary can have at least one positioning projection and the second boundary can have at least one undercut formed congruently with the positioning projection, the positioning projection of one of the carrier plates being arranged in the undercut of the adjacently adjoining other carrier plate. As a result, the mutually adjacent carrier plates are positioned precisely with respect to each other, and the assembly of the valve arrangement itself and the mounting of the valve arrangement on the housing are thereby facilitated.

The carrier plates can be made of a hard and tough polymeric material. This makes the carrier plates simple and cost-efficient to manufacture. In addition, the weight is low and the carrier plates can be easily recycled if necessary.

The ventilation valves can have differing functionalities. It is advantageous hereby that several ventilation valves with differing functionalities can be combined in the modular valve arrangement to form an advantageous overall module with optimized usage properties for the specific application.

The adjacent ventilation valves are preferably arranged in a functional parallel circuit. This allows for a high ventilation performance to be achieved with low space requirements. It is not necessary to use one particularly large ventilation valve, for which there is often no space on the housing. Several small ventilation valves in a functional parallel circuit fulfill functionally the same purpose.

The valve arrangement can be configured as a pressure compensation valve arrangement, in which case the ventilation valves are formed by pressure compensation valves. Such a pressure compensation valve is disclosed, for example, in the DE 10 2017 003 360 B3 mentioned at the beginning.

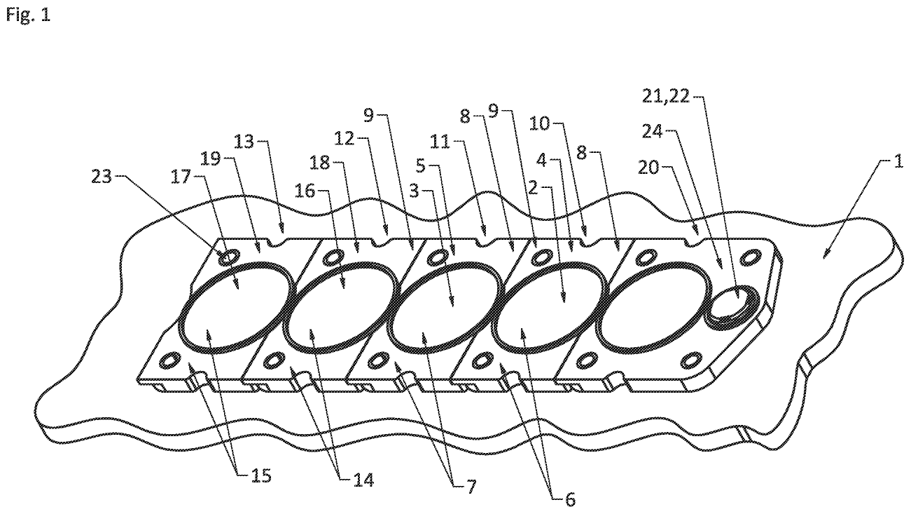

FIGS. 1 to 10 show an exemplary embodiment of a modular valve arrangement for a housing 1.

FIG. 1 shows the valve arrangement mounted on the housing 1. The housing 1 can be configured as a battery housing in the field of e-mobility. In this context, the valve arrangement comprises at least two, in the shown embodiment four modules 10, 11, 12, 13, which are formed by pre-assemblable units 6, 7, 14, 15. The pre-assemblable units 6, 7, 14, 15 comprise the ventilation valves 2, 3, 16, 17 and their corresponding carrier plates 4, 5, 18, 19.

On the longitudinal side on one side of the valve arrangement the end piece 20 is mounted, which on its side facing the modules 10, 11, 12, 13 has a second longitudinal boundary 9, corresponding to the second longitudinal boundaries 9 of the modules 10, 11, 12, 13. On the side of the end piece 20 facing away from the second longitudinal boundary 9, the end piece 20, viewed in a top view, is essentially roof-shaped. On the side of the first longitudinal boundary 8 of the end piece 20 facing away from the modules 10, 11, 12, 13, a further valve 21 is provided, which is covered by a valve cover 22 on the upper side of the valve arrangement. The further valve 21 is also configured as a ventilation valve.

In the shown exemplary embodiment, the modules 10, 11, 12, 13 are configured as common parts. Both the ventilation valves 2, 3, 16, 17 being used in the application and the corresponding associated carrier plates 4, 5, 18, 19 each are common parts. However, depending on the respective conditions of the application, it is also possible to configure at least one of the ventilation valves 2, 3, 16, 17 differently. Thus, the valve arrangement can be adapted even better to the respective conditions of the application. Even in such a case, however, the carrier plates 4, 5, 18, 19 would be configured as common parts. This is of decisive advantage for the modular structure of the valve arrangement.

The ventilation valves 2, 3, 16, 17 can, for example, be formed by pressure compensation valves, such as one disclosed in DE 10 2017 003 360 B3.

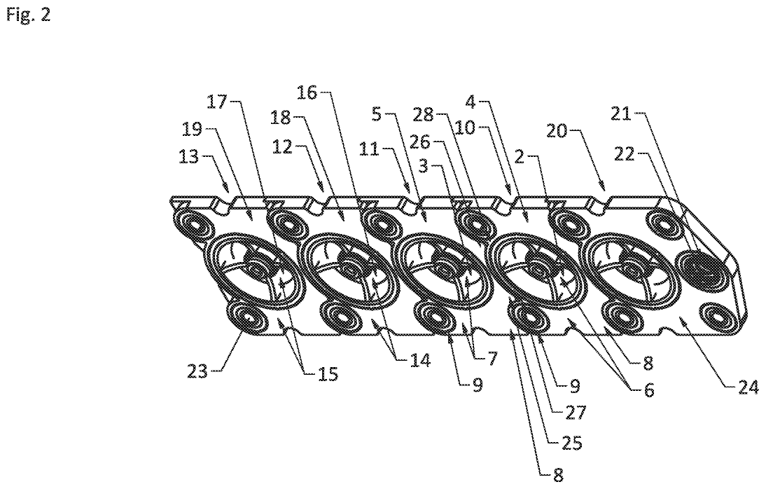

The upper surface of the interconnected carrier plates 4, 5, 18, 19 and also the underside of the mounted carrier plates 4, 5, 18, 19, which is shown in FIG. 2, are in each case free from erratic changes in direction, i.e. they are configured evenly.

In the exemplary embodiment shown, the carrier plates 4, 5, 18, 19 have holes 23 in the area of their respective longitudinal boundaries 8, 9, which are penetrated by screws during the intended use of the valve arrangement. These screws are used to fasten the valve arrangement to the housing 1.

For easier positioning of the modules 10, 11, 12, 13 and the end piece 20, the corresponding carrier plates 4, 5, 18, 19 are each provided with two positioning projections 25, 26, which are arranged in congruently configured undercuts 27, 28 of the corresponding adjacent carrier plates 4, 5, 18, 19, 24.

The corresponding modules 10, 11, 12, 13 and also the end piece 20 complement each other in their function. They are arranged in a functional parallel circuit.

FIG. 2 shows the valve arrangement from FIG. 1 as an individual part in a perspective view from below. It can be seen clearly that the positioning projections 25, 26 described above engage in the congruently configured undercuts 27, 28 and thereby position the respective modules 10, 11, 12, 13 and also the end piece 20 to fit one another.

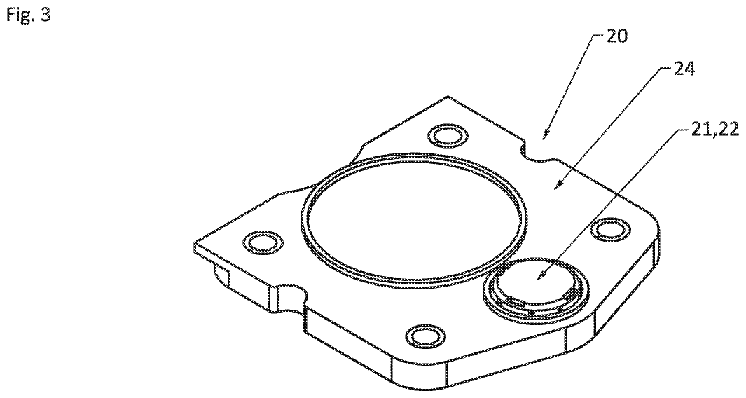

FIGS. 3 to 6 each show the end piece 20 as an individual part. FIG. 3 shows the end piece 20 in a perspective top view. The additional valve 21 covered by the valve cover 22 is clearly visible here. The valve cover 22 is arranged in a raised position on the surface of the end piece 20.

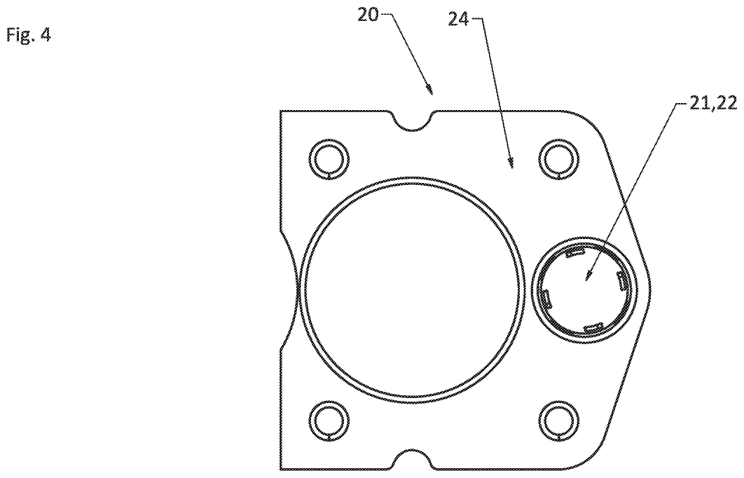

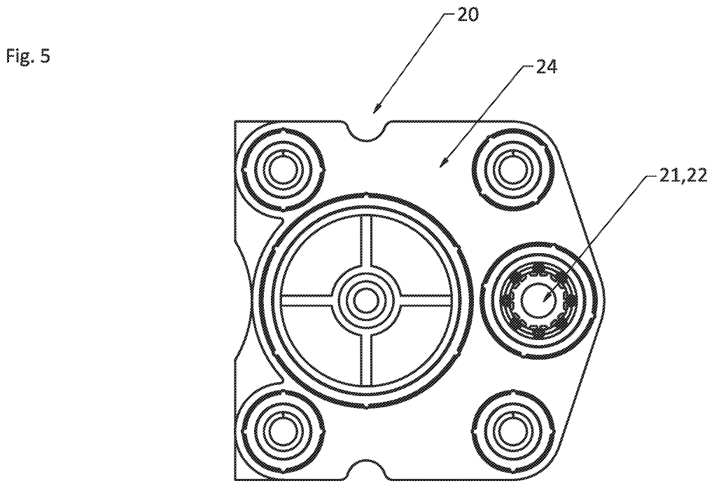

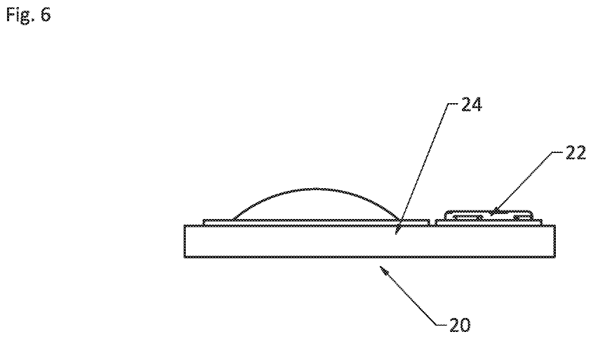

FIG. 4 shows a top view of the end piece 20, FIG. 5 shows a view from below. FIG. 6 shows a front view of the end piece 20 from FIG. 3.

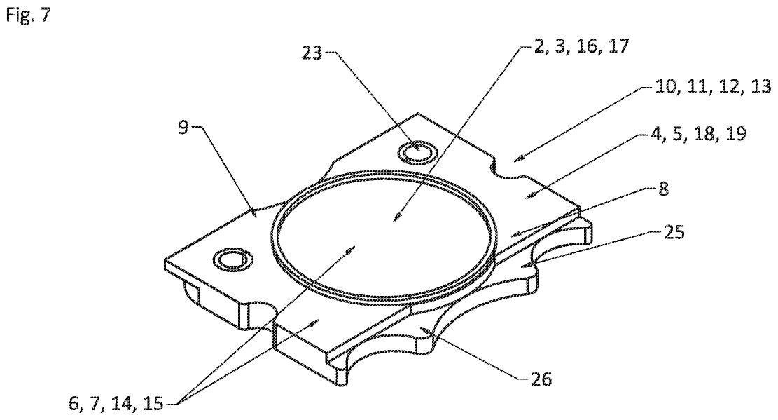

In FIGS. 7 to 10, one of the modules 10, 11, 12, 13 is shown as an individual part. Modularity allows an infinite expandability.

FIG. 7 shows a perspective top view of one of the modules 10, 11, 12, 13.

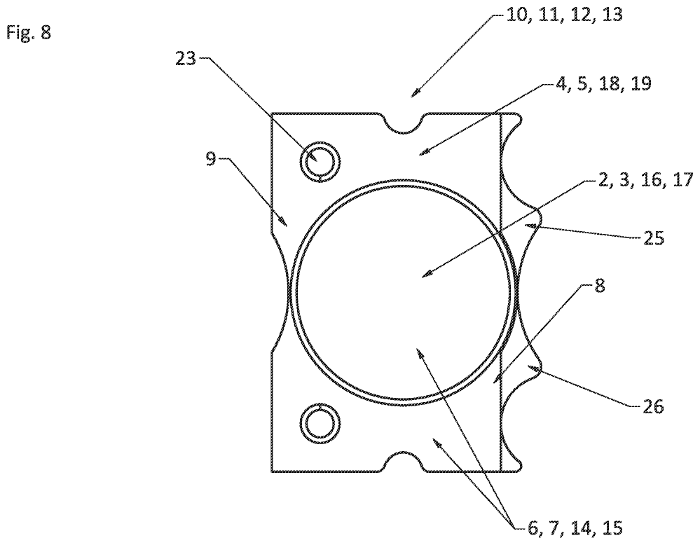

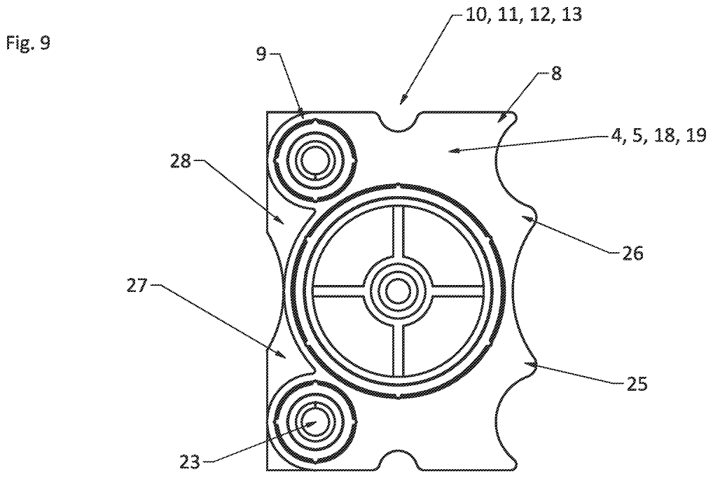

FIG. 8 shows a top view of one of the modules 10, 11, 12, 13, 14, FIG. 9 shows the module 10, 11, 12, 13 from FIG. 8 from below. It can be seen that the carrier plate 4, 5, 18, 19 has a first 8 and a second longitudinal boundary 9, the first boundary 8 being engageable with the second boundary 9 of an adjacent adjoining other carrier plate. The connection is made by engaging positioning projections 25, 26 from one carrier plate with congruently shaped undercuts 27, 28 of an adjacent carrier plate, as shown in FIG. 2.

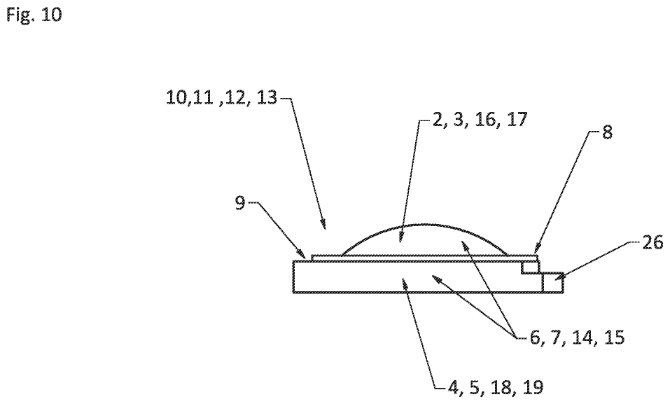

FIG. 10 shows a front view of the module 10, 11, 12, 13 from FIG. 8.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A modular valve arrangement for a housing, comprising:
at least two ventilation valves; and
at least two carrier plates,
wherein each ventilation valve is accommodated by a carrier plate of the at least two carrier plates, and
wherein the ventilation valves are connected to each other in a modular manner by their corresponding carrier plate.

2. The valve arrangement according to claim 1, wherein the ventilation valves each form a pre-assemblable unit with their corresponding carrier plates.

3. The valve arrangement according to claim 1, wherein the ventilation valves and the corresponding carrier plates are connected to each other in a materially bonded manner.

4. The valve arrangement according to claim 1, wherein the ventilation valves and the corresponding carrier plates are non-destructively detachably connected to each other.

5. The valve arrangement according to claim 4, wherein the ventilation valves and the corresponding carrier plates are connected to each other by a force-fitting and/or form-fitting connection.

6. The valve arrangement according to claim 1, wherein the carrier plates each have a first and a second longitudinal boundary, and
wherein the first boundary of one of the carrier plates is connected to the second boundary of an adjacently adjoining other carrier plate in a force-fitting and/or form-fitting manner.

7. The valve arrangement according to claim 6, wherein the first boundary has at least one positioning projection and the second boundary has at least one undercut formed congruently with the positioning projection, and
wherein the positioning projection of one of the carrier plates is arranged in the undercut of the adjacently adjoining other carrier plate.

8. The valve arrangement according to claim 1, wherein the carrier plates are made of a hard and tough polymeric material.

9. The valve arrangement according to claim 1, wherein the ventilation valves have functionalities differing from one another.

10. The valve arrangement according to claim 1, wherein the ventilation valves adjacent to each other are arranged in a functional parallel circuit.

11. The valve arrangement according to claim 1, wherein the valve arrangement is configured as a pressure compensation valve arrangement, and
wherein the ventilation valves are formed by pressure compensation valves.
